(19) United States
(12) Patent Application Publication
(10) Pub. No.: US 2011/0039451 A1
(43) Pub. Date: Feb. 17, 2011

(54) CONNECTOR SOCKET STRUCTURE

(76) Inventor: Zhang TUNG, Taipei County (TW)

Correspondence Address: RABIN & Berdo, PC, 1101 14TH STREET, NW, SUITE 500, WASHINGTON, DC, 20005, US

(21) Appl. No.: 12/631,920

(22) Filed: Dec. 7, 2009

(30) Foreign Application Priority Data
Aug. 14, 2009 (TW) 098215075

(51) Int. Cl. H01R 13/66

(52) U.S. Cl. 439/620.23

(57) ABSTRACT

This invention relates to a connector socket structure, including a main socket structure, two terminal bases, two USB terminals, two eSATA terminals, one first fixing cap, one RJ45 networking unit, one second fixing cap, one rear shell and one front shell, so as to provide a rigid structure for RJ45 networking function and to enable two individual multi-purpose sockets which simultaneously fit standard USB2.0, USB3.0 and eSATA three-in-one connection.

### PRIOR ART

Accordingly, prior application of eSATA (External Serial Advanced Technology Attachment) interface is used as a connection with an external hard drive. It provides an efficient and quick data transferring rate between 40 MB and 70 MB per second depending on the different specification of hard drive. And, the USB (Universal Serial Bus) is a standard connection interface that allows the external devices and the computer connected without reconfiguring the entire system. The computer will automatically recognize those peripheral devices and assign drivers to boot them without any reset procedure from the computer user. The USB 2.0 interface had been applied in mouse, printer, sound card . . . , etc. at a data transferring rate up to 480 MB per second. Furthermore, the USB 3.0 interface works at a is higher rate and is scheduled to put into the market in the very near future. However, different peripheral with individual specification of interface has to be connected with specialized socket which can not fit the others. The computer manufacturer and/or its supplier have to provide their products with different specification of sockets to connect each peripheral with USB2.0, USB3.0 or eSATA interface. Though, there is certain connector structure can provide above-mentioned three-in-one connection. The insertion mode is not the same as its prior normal operation. That three-in-one socket might need to be connected with an up-side-down insertion which is different from the standard specification. It could confuse the users and lead to damage both to the connector and the socket structure. Obviously, the prior connector socket structure still can't comply with the user's requirements.

### SUMMARY OF THE INVENTION

The primary purpose of the present invention is to provide a connector socket structure. With the combination of a main socket structure, two terminal bases, two USB (Universal Serial Bus) terminals, two eSATA (External Serial Advanced Technology Attachment) terminals, one first fixing cap, one RJ45 networking unit, one second fixing cap, one rear cap and one front shell, the present invention puts all three standard USB2.0, USB3.0 and eSATA connection into one socket with the same insertion mode and direction of connector. The present invention minimizes the entire volume of connectors and enhances the total function and convenience of prior three connectors.

Another purpose of the present invention is to provide a connector socket structure equipping with at least a light-guiding post in the second lateral holding space of the main socket structure. The lower side of each light-guiding post is installed with a corresponding LED (Light Emitting Diode) extended with two pins passing through the second fixing cap. The front shell sets up light-guiding gaps corresponding to mentioned at least one light-guiding post to enable color light indication from LED to show the working status which definitely increases the operational convenience of the present invention.

Still another purpose of the present invention is to provide a connector socket structure, by setting each dovetail rabbet of protruding parts in both sides of each terminal base to fit dovetail block located at both sides of each first lateral holding space inside the main socket structure, to form corresponsive upper and lower sliding stoppers at both sides of each first lateral holding space inside the main socket structure to block both upper and lower front stoppers at fore end of protruding part at each side of terminal base and to prevent it from moving ahead and ensure the whole joint structure firmly fixed. And, there is at least one stopping hook formed at the lower side of each first lateral holding space inside the main socket structure to block the holding rabbet at the lower rear of terminal base and prevent it moving backward. Also, those five terminal rabbets located at the upper side of each terminal base extend forward until the lower front and form each slanting space to fit those corresponding five forward crooked bending pins in slanting shape among the eSATA terminals. Besides, the front end of both side pins of eSATA terminals are formed into sloping parts to embed in both walls of front ends of terminal rabbets at upper sides of terminal base. Meanwhile, both side pins in the mid of eSATA terminals are shaped as barbs to firmly stab into the terminal base. Furthermore, there is an extension plate formed at the top of each first lateral holding space of the is main socket structure, and the rear part of those five upward bending pins of each eSATA terminals are set over the terminal base to limit that extension plate which firmly presses and seize up those five upward bending pins. Besides, both sides of those four bending pins in the USB terminals are also shaped as barbs to firmly stab into the terminal base to increase the strength and stability of the socket structure.

Still another purpose of the present invention is to provide a connector socket structure which equips a fastener combination between lateral hooks at both lower sides of the first and the second fixing caps and protruding hooks at the lower inner sides of the main socket structure. Then, the plural extension parts in the first and the second fixing caps firmly joint the lower inner sides of the main socket structure. There are holding parts set each side at the back of the vertical holding space to guard the second fixing cap. Furthermore, the lower inner side of the first fixing cap is formed as a serial rabbet to match the lower part of the main socket structure to guide those four USB bending terminals passing through. After that, there are three sets of pins holes (seven holes, four holes and seven holes in straight) serially set at the bottom side of the first fixing cap for eSATA and USB bending pins passing through. Extended from the bottom of the second fixing cap are ten terminals which provide the normal operation of RJ45 interface and the power for the transformer in the RJ45 networking unit. There are another four pins extended at the very rear side of the second fixing cap installed for the power of two light-guiding LEDs.

One more purpose of the present invention is to provide a connector socket structure which a plural of folding plates are processed at the rim of the front shell. And, a plural of punctures are manufactured over those folding plates. Accordingly, a plural of folding piece are processed at the rim of the rear shell to assemble with those punctures in the front shell. There are also a plural of elastic parts formed in the front shell. And, a plural of fixing feet are set at the bottom of the rear shell.

To achieve above-mentioned purposes, the present invention provides a connector socket structure which comprising a main socket structure, two terminal bases, two USB (Universal Serial Bus) terminals, two eSATA (External Serial Advanced Technology Attachment) terminals, one first fixing cap, one RJ45 networking unit, one second fixing cap, one rear cap and one front shell to offer dual sockets with three standard connector function (USB2.0, USB3.0 and eSATA) plus a stability enhanced RJ45 networking unit for computer related application.

To enable a further understanding of the said objectives and the technological methods of the invention herein, the brief description of the drawings below is followed by the detailed description of the preferred embodiments.

### BRIEF DESCRIPTION OF THE FIGURES

FIG. 1 illustrates a three-dimensional appearance of the present invention.

FIG. 2 illustrates a three-dimensional element decomposition view of the present invention.

FIG. 3 illustrates another three-dimensional element decomposition view of the present invention.

FIG. 4 illustrates the enlarged three-dimensional element decomposition view of the terminal base, USB terminals and eSATA terminals of the present invention.

FIG. 5 illustrates another enlarged three-dimensional element decomposition view of the terminal base, USB terminals and eSATA terminals of the present invention.

FIG. 6 illustrates an assembled front view of the FIG. 4.

FIG. 7 illustrates an A-A schematic cross-section view of the FIG. 6.

FIG. 8 illustrates an assembled front view of the present invention.

FIG. 9 illustrates a B-B schematic cross-section view of the FIG. 8.

FIG. 10 illustrates a C-C schematic cross-section view of the FIG. 8

FIG. 11 illustrates an assembled side view of the present invention.

FIG. 12 illustrates a D-D schematic cross-section view of the FIG. 11.

FIG. 13 illustrates an assembled upward view of the present invention.

### DETAILED DESCRIPTION OF THE PREFERRED EMBODIMENTS

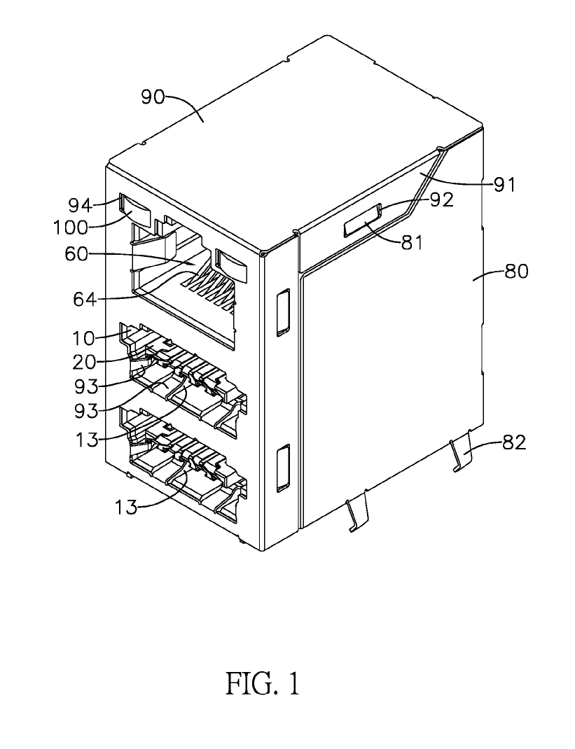

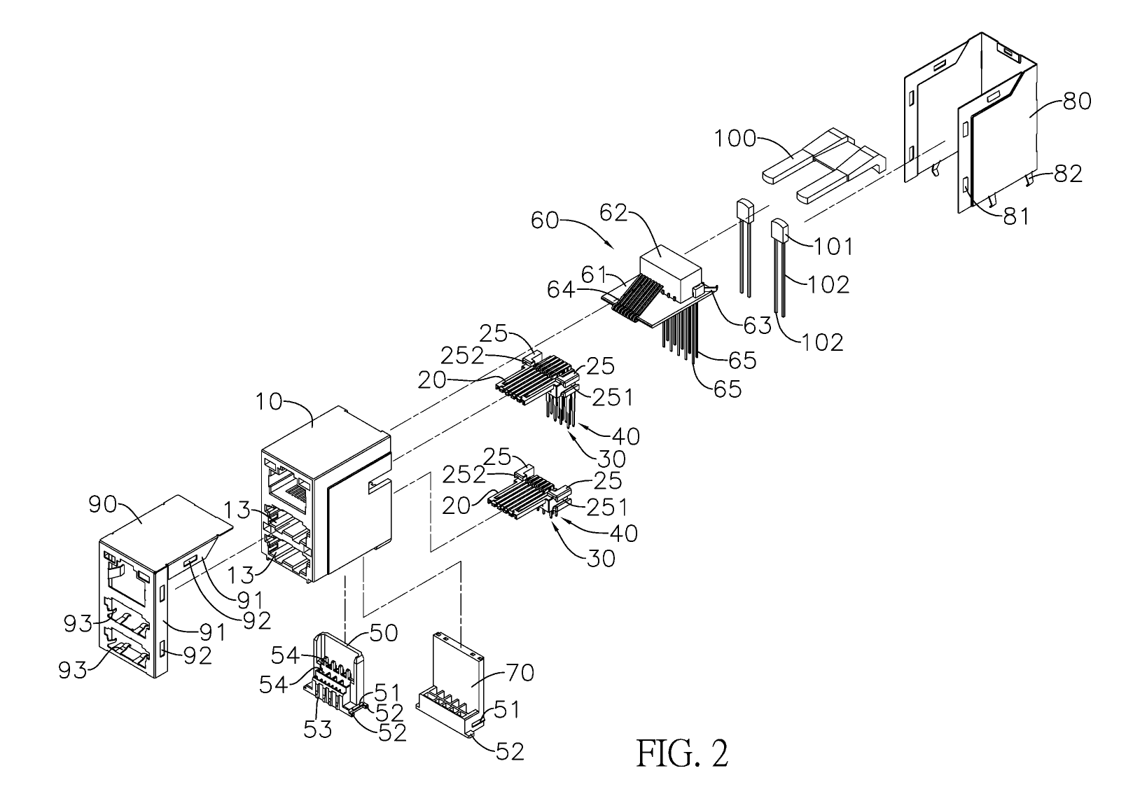

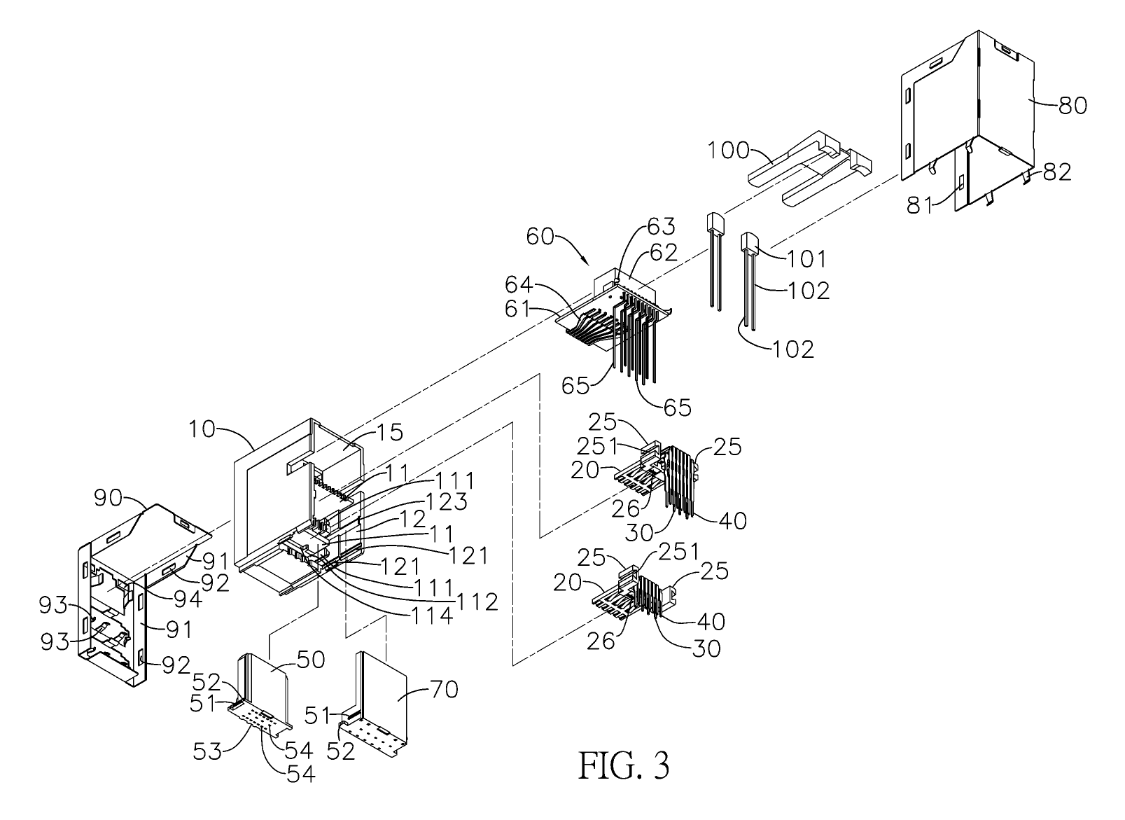

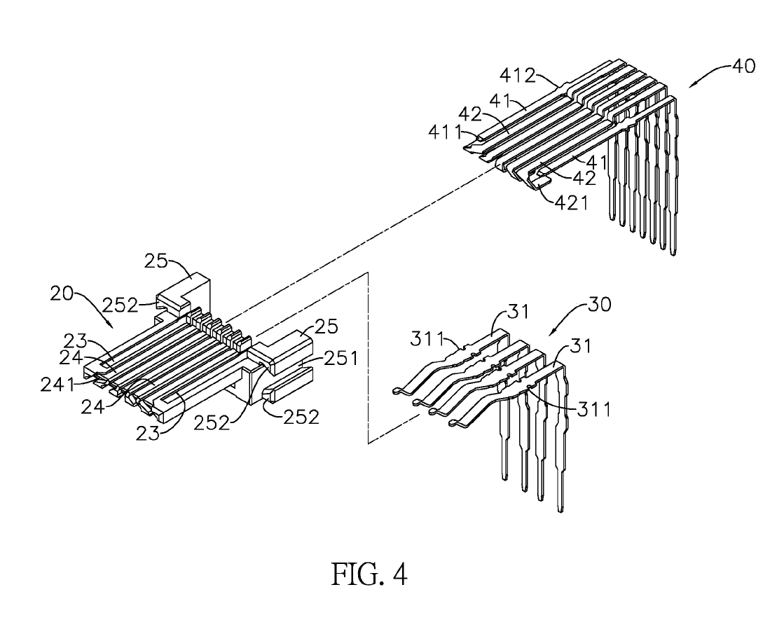

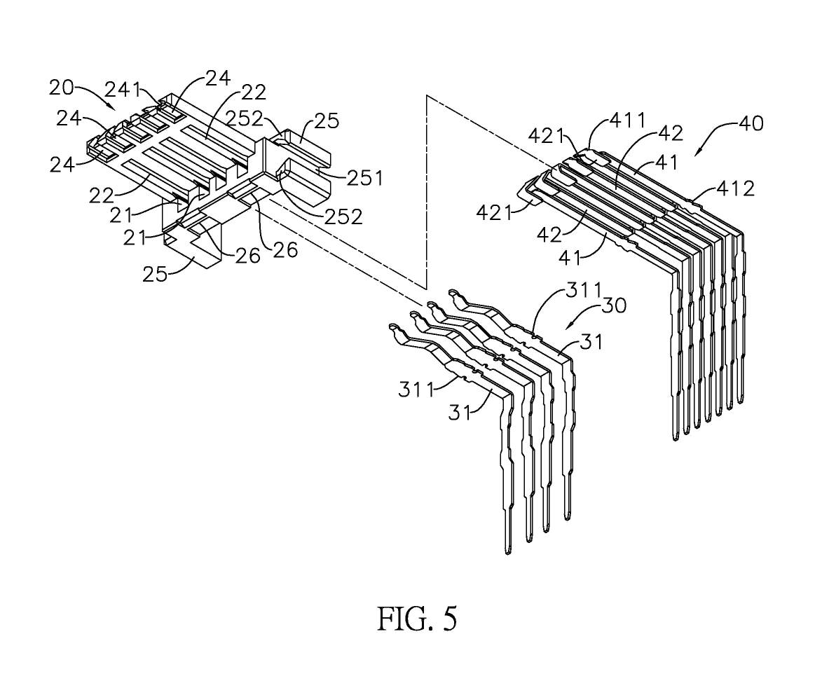

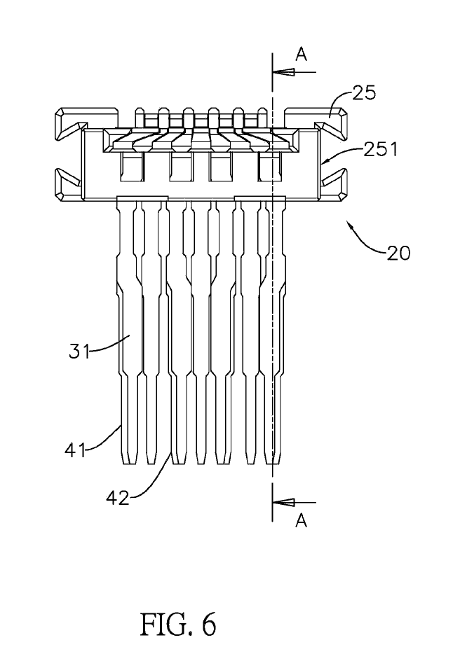

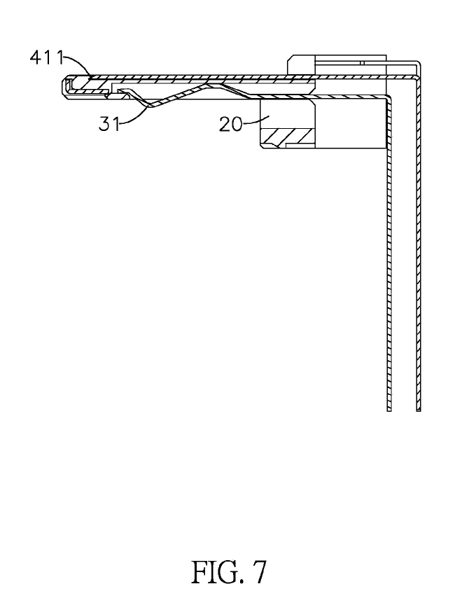

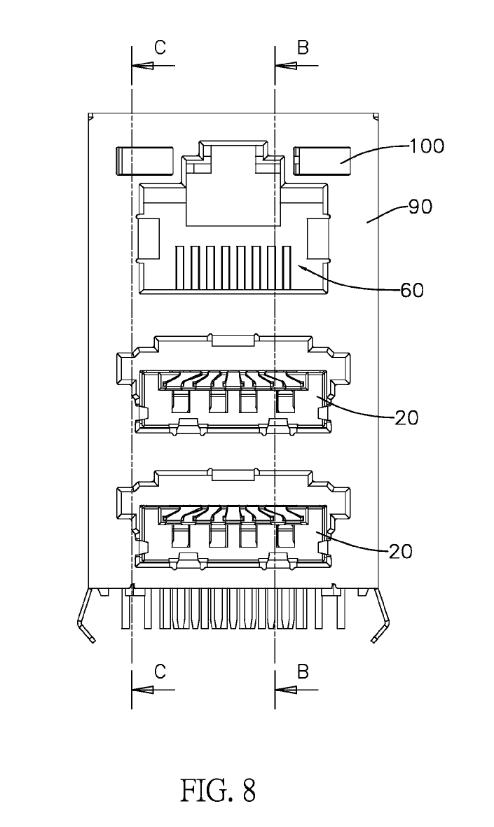

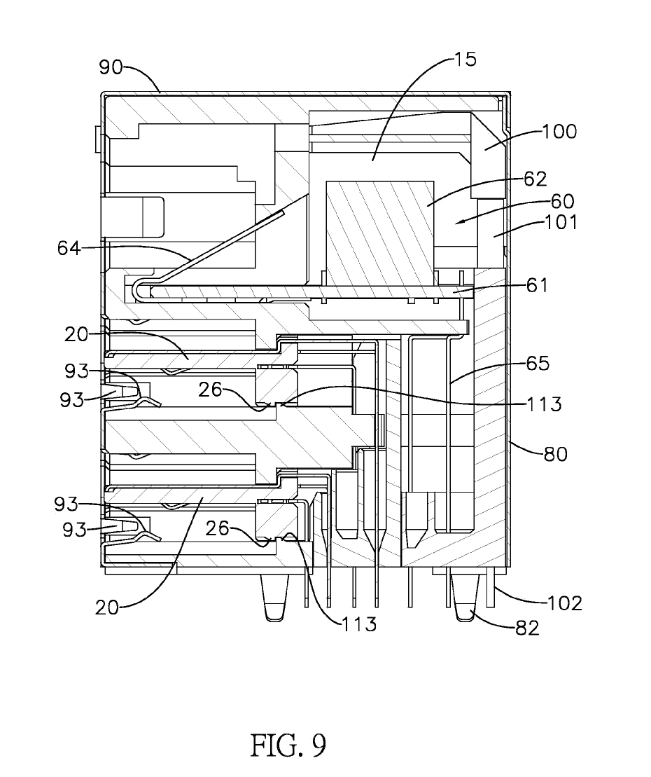

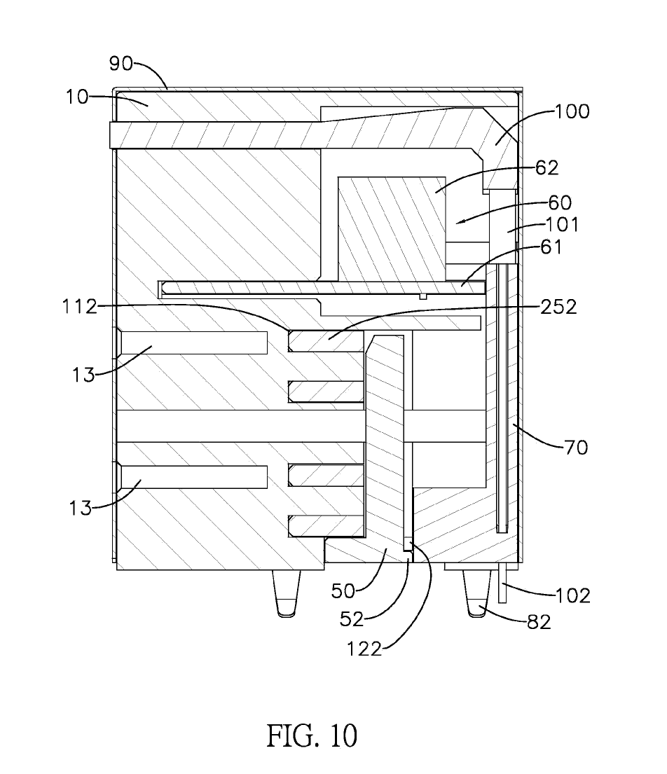

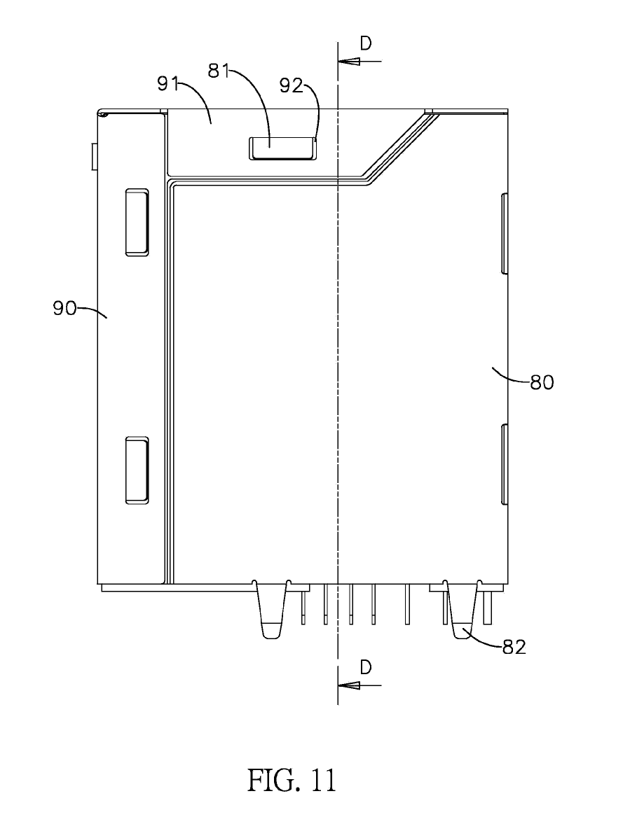

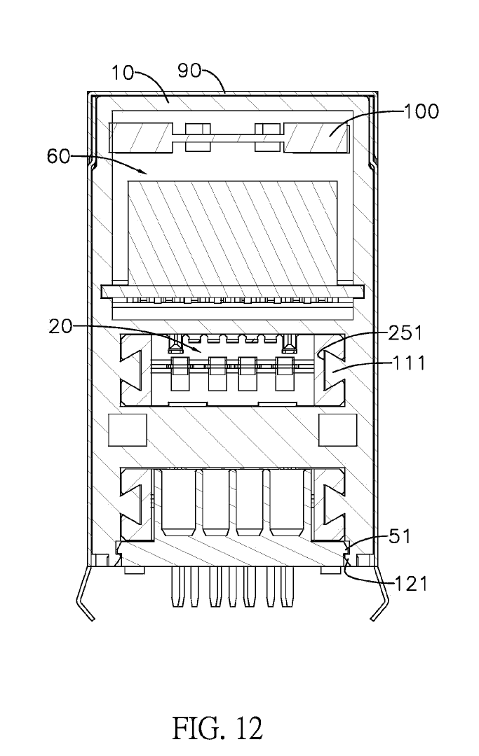

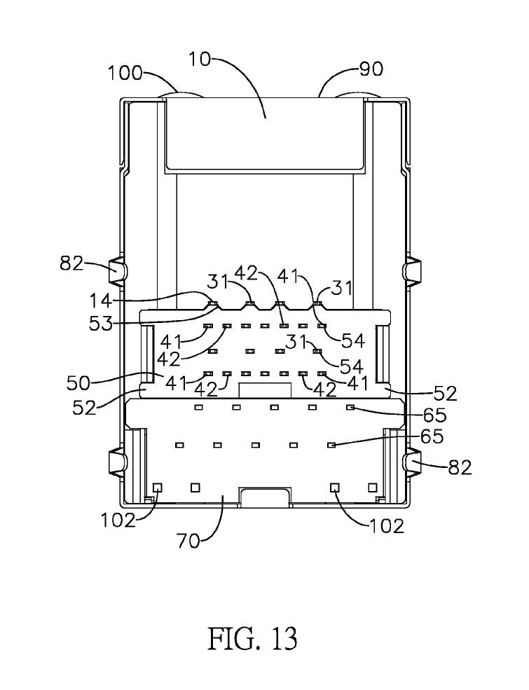

The present invention relates to a connector socket structure (please refer to FIG. 1 to FIG. 13), which primarily includes:

a main socket structure 10, wherein the main socket structure 10 consists of two first lateral holding space 11, one second lateral holding space 15 and one vertical holding space 12;

two terminal bases 20, wherein two terminals bases 20 are separately assembled from backward to forward inside two first lateral holding space 11 to form a multi-purpose socket 13 (combining with an USB2.0, an USB 3.0 and an eSATA terminals), and there are four holes 21 passing through fore and aft with corresponding four terminal rabbets 22 formed at the lower side of each terminal base 20, both ends at the upper side of the terminal base 20 containing one terminal rabbet 23, and there are another five terminal rabbets 24 lying between these two ones and leading forward is to the lower front of the terminal base 20;

two USB terminals 30, wherein the four bending pins 31 of each USB terminal 30 passing through those four holes 21 and firmly fixed inside the terminal rabbets 22 at the lower side of each terminal base 20 to provide USB 2.0 connection;

two eSATA terminals 40, wherein each of the two bending pins 41 installed in the side terminal rabbets 23 and five forward crooked ones (bending pins 42) are installed into those corresponding terminal rabbets 24 and extended until the lower front of the terminal base 20, meanwhile, two bending pins 41 and five bending pins 42 with front hooks 421 play the function of eSATA connector, and, the front lower contact points of those five bending pins 42 are also shared as the common terminals together with said the four bending pins 31 (totally nine terminals) to work as the connector of SB 3.0;

a first fixing cap 50, which is installed upward from the lower and fit into the vertical holding space 12 of the main socket structure 10, and allowing the bending pins 31, 41, 42 of those two USB terminals 30 and two eSATA terminals 40 to extend through the other side;

a RJ45 networking unit 60, which is assembled from backward to forward to fit in the second holding space 15 of the main socket structure 10, and the RJ45 networking unit 60 consists of a circuit board 61, a transformer 62, a pair of grounding parts 63, eight RJ45 bending pins 64 and ten terminals, and under such a combination, the transformer 62 and the grounding parts 63 are installed in the circuit board 61 with ten terminals 65 installed at the rear, two of those ten terminals 65 are connected for power and the others (terminals 65) are for the networking function;

a second fixing cap 70, which is assembled upward from the lower to is insert into the vertical holding space 12 of the main socket structure 10, and allows said ten terminals 65 of the RJ45 networking unit 60 to pass through from the other side;

a rear shell 80, which is installed at the back side of the main socket structure 10 and have a contact with a pair of grounding parts 63; and

a front shell 90, which is installed at the front of the main socket structure 10 and is mutual combined with the rear shell 80.

In addition, the second lateral holding space 15 of the main socket structure 10 installs at least a light-guiding post 100 with a LED 101 at its lower side, and two pins 102 extended from the LED 101 passing through the second fixing cap 70, and at least one light-guiding gap 94 in the front shell 90 to show the working status which will increase the operational convenience of the present invention.

And, each dovetail rabbet 251 of protruding parts 25 is set in both sides of each terminal base 20 to fit dovetail block 111 located at both sides of each first lateral holding space 11 inside the main socket structure 10, to form corresponsive upper and lower sliding stoppers 112 at both sides of each first lateral holding space 11 and block both upper and lower front stoppers 252 at fore end of protruding part 25 at each side of terminal base 20 and to prevent it from moving ahead and ensure the whole joint structure firmly fixed.

And, there is at least one stopping hook 113 formed at the lower side of each first lateral holding space 11 inside the main socket structure 10 to block the holding rabbet 26 at the lower rear of terminal base 20 and prevent it moving backward.

Those five terminal rabbets 24 located at the upper side of each terminal base 20 extend forward until the lower front hooks 421 and form is each slanting space 241 to fit those corresponding five forward crooked bending pins 42 in slanting shape among the eSATA terminals 40. Besides, the front end of both side bending pins 41 of eSATA terminals 40 are formed into sloping parts 411 to embed in both walls of front ends of terminal rabbets 23 at upper sides of each terminal base 20. Meanwhile, both side bending pins 41 in the mid of eSATA terminals 40 are shaped as barbs 412 to firmly stab into the terminal base 20. Furthermore, there is an extension plate 114 formed at the top of each first lateral holding space 11 of the main socket structure 10, and the rear part of those five upward bending pins 42 of each eSATA terminals 40 are set over the terminal base 20 to limit that extension plate 114 which firmly presses and seize up those five upward bending pins 42. Besides, both sides of those four bending pins 31 in the USB terminals 30 are also shaped as barbs 311 to firmly stab into the terminal base 20 to increase the strength and stability of the socket structure.

Also, the present invention presents a fastener combination between the lateral hooks 51 at both lower sides of the first and the second fixing caps 50, 70 and protruding hooks 121 at the lower inner sides of the main socket structure 10. Then, the plural extension parts 52 in the first and the second fixing caps 50, 70 firmly joint the lower inner sides of the main socket structure 10. There are holding parts 123 set each side at the back of the vertical holding space 12 to guard the second fixing cap 70.

Furthermore, the lower inner side of the first fixing cap 50 is formed as a serial rabbet 53 to match the lower part of the main socket structure 10 to guide those four USB bending pins 31 passing through. After that, there are three sets of pin holes 54 (seven holes, four holes and seven holes in straight) serially set at the bottom side of the first fixing cap 50 for eSATA and USB bending pins 31, 41, 42 passing through. Extended from the bottom of the second fixing cap 70 are ten terminals 65 which provide the normal operation of RJ45 interface and the power for the transformer 62 with a filtering circuit (not shown in the figure) in the RJ45 networking unit 60. There are another four pins extended at the very rear side of the second fixing cap 70 installed for the power of two light-guiding LEDs 101.

Last, there are a plural of folding plates 91 are processed at the rim of the front shell 90. And, a plural of punctures 92 are manufactured over those folding plates 91. Accordingly, a plural of folding piece 81 are processed at the rim of the rear shell 80 to assemble with those punctures 92 in the front shell 90. There are also a plural of elastic parts 93 formed in the front shell 90. And, a plural of fixing feet 82 are set at the bottom of the rear shell 80.

In short, from the description related to the structure and hardware elements mentioned above, the present invention provides a multi-purpose connector which affords to work for RJ45 internet connection and USB 2.0, USB 3.0 and eSATA simultaneously.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A connector socket structure, comprising:
a main socket structure, wherein the main socket structure consists of two first lateral holding space, one second lateral holding space and one vertical holding space;
two terminal bases, wherein two terminals bases are separately assembled from backward to forward with two first lateral holding space, four holes and corresponding four terminal rabbets at the lower side of each terminal base are organized, both ends at the upper side of the terminal base containing one terminal rabbet, and there are five terminal rabbets lying between these two ones and leading forward to the lower front of the terminal base;
two USB terminals, wherein the four bending pins of each USB terminal passing through those four holes and firmly fixed inside the terminal rabbets at the lower side of each terminal base;
two eSATA terminals, wherein there are two bending pins each installed in the side terminal rabbets and five forward crooked ones are installed into those corresponding terminal rabbets mentioned above;
a first fixing cap, wherein the first fixing cap is assembled upward from the lower to insert into the vertical holding space of the main socket structure, and allowing the bending pins of those two USB terminals and two eSATA terminals to pass through the other side;
a RJ45 networking unit, wherein the RJ45 networking unit is assembled from backward to forward to fit in the second holding space of the main socket structure, and the RJ45 networking unit consists of a circuit board, a transformer, a pair of grounding parts, eight RJ45 bending pins and ten terminals, and under such a combination, the transformer and the grounding parts are installed in the circuit board with ten terminals installed at the rear, two of those ten terminals are connected for power and the others are for the networking;
a second fixing cap, wherein the second fixing cap is assembled upward from the lower to insert into the vertical holding space of the main socket structure, and allows said ten terminals of the RJ45 networking unit to pass through from the other side;
a rear shell, wherein the rear shell is installed at the back side of the main socket structure and set with a plural of fixing feet at the bottom of the rear shell, and have a contact with a pair of grounding parts extended from the RJ45 networking unit; and
a front shell, wherein the front shell is installed at the front of the main socket structure and formed with a plural of elastic parts, and is mutual combined with the rear shell.

2. A connector socket structure according to claim one, wherein both sides of each terminal bases are formed into a protruding part with a dovetail rabbet to accommodate the dovetail block located both inside two of the first lateral holding space in the main socket structure.

3. A connector socket structure according to claim two, wherein the upper and the lower sliding stoppers at both sides of each first lateral holding space inside the main socket structure firmly contact and block the corresponsive front stoppers at both sides of terminal base.

4. A connector socket structure according to claim one, wherein there is at least one stopping hook formed at the lower side of each first lateral holding space inside the main socket structure to block the holding rabbet at the lower rear of terminal base.

5. A connector socket structure according to claim two, wherein there is at least one stopping hook formed at the lower side of each first lateral holding space inside the main socket structure to block the holding rabbet at the lower rear of terminal base.

6. A connector socket structure according to claim three, wherein there is at least one stopping hook formed at the lower side of each first lateral holding space inside the main socket structure to block the holding rabbet at the lower rear of terminal base.

7. A connector socket structure according to claim one, wherein there exists the plural extension parts in the first and the second fixing caps and a fastening combination between lateral hooks at both lower sides of the first and the second fixing caps and protruding hooks at the lower inner sides of the main socket structure.

8. A connector socket structure according to claim seven, wherein there are holding parts set each side at the back of the main socket structure to guard the second fixing cap inserted into the vertical holding space.

9. A connector socket structure according to claim one, wherein the lower inner side of the first fixing cap is formed as a serial rabbet to match the lower part of the main socket structure, and there are three sets of pins holes (seven holes, four holes and seven holes in straight) serially set at the bottom side of the first fixing cap.

10. A connector socket structure according to claim seven, wherein the lower inner side of the first fixing cap is formed as a serial rabbet to match the lower part of the main socket structure, and there are three sets of pins holes (seven holes, four holes and seven holes in straight) serially set at the bottom side of the first fixing cap.

11. A connector socket structure according to claim eight, wherein the lower inner side of the first fixing cap is formed as a serial rabbet to match the lower part of the main socket structure, and there are three sets of pins holes (seven holes, four holes and seven holes in straight) serially set at the bottom side of the first fixing cap.

12. A connector socket structure according to claim one, wherein those five terminal rabbets located at the upper side of each terminal base extend forward until the lower front and form each slanting space to fit those corresponding five forward crooked bending pins in slanting shape.

13. A connector socket structure according to claim one, wherein the front end of both side pins of eSATA terminals are shaped as barbs and formed into sloping parts to embed in both walls of front ends of terminal rabbets at upper sides of terminal base

14. A connector socket structure according to claim one, wherein an extension plate is formed at the top of each first lateral holding space of the main socket structure, and the rear part of those five upward bending pins of each eSATA terminals are set over the terminal base.

15. A connector socket structure according to claim one, wherein a plural of folding plates with punctures are processed at the rim of the front shell to assemble with a plural of folding piece processed at the rim of the rear shell accordingly.

16. A connector socket structure according to claim one, wherein both sides of those four bending pins of the USB terminals are shaped as barbs and stab into the terminal base.

17. A connector socket structure according to claim one, wherein the second lateral holding space of the main socket structure installs at least a light-guiding post with a LED at its lower side, and two pins extended from the LED passing through the second fixing cap, and at least one light-guiding gap in the front shell.

18. A connector socket structure according to claim one, wherein the transformer of the RJ45 networking unit and a pair of elastic parts are installed by a DIP (Dual In-Line Package) method on the circuit board.

19. A connector socket structure according to claim one, wherein the circuit board of the RJ45 networking unit includes a band-pass filtering circuit.
